(19) United States
(12) Patent Application Publication
(10) Pub. No.: US 2011/0215185 A1
(43) Pub. Date: Sep. 8, 2011

(54) BELT RETRACTOR HAVING A FORCE LIMITATION DEVICE

(76) Inventors: Günter Clute, Elmshorn (DE); Jon Burrow, Ortonville, MI (US)

(21) Appl. No.: 13/130,350

(22) PCT Filed: Nov. 18, 2009
(86) PCT No.: PCT/EP09/08191

§ 371 Date: May 20, 2011

(30) Foreign Application Priority Data
Nov. 27, 2008 (DE) 10 2008 059 386.9

(51) Int. Cl. B60R 22/34; B60R 22/46; B60R 22/36

(52) U.S. Cl. 242/374; 242/376

(57) ABSTRACT

Disclosed is a seat belt retractor with a two-part belt shaft including a first part (1) of the belt shaft, upon which the safety belt (2) is wound, and a second part (5) of the belt shaft, which can be locked in a vehicle-fixed manner in relation to a housing (8) of the seat belt retractor. A load limiting device (3) is located between the first (1) and the second part (5) of the belt shaft. The first (1) and the second part (5) of the belt shaft axially overlap at least in sections, and a bearing ring (13) is provided in the overlapping area.

### TECHNICAL FIELD

The invention relates to a seat belt retractor with a load limiting device.

### BACKGROUND OF THE INVENTION

Seat belt retractors with load limiting devices are generally known and have the function to allow a load limited forward displacement of the passenger during the accident. For this purpose, seat belt retractors of this kind comprise a two-part belt shaft and a load limiting device located between the parts of the belt shaft. In that case, the safety belt restraining the passenger is fastened to one part of the belt shaft, whereas the other part of the belt shaft can be locked in relation to the vehicle-fixed housing of the seat belt retractor. When the seat belt retractor is locked and a force defined by the load limiting device is exceeded, the part of the belt shaft, to which the safety belt is fastened, can rotate in the belt extraction direction, at the same time activating the load limiting device. Thereby, the load acting upon the passenger is limited to the level defined by the load limiting device.

From DE 196 81 341 C1, for example, a seat belt retractor comprising a two-part belt shaft with a torsion bar inserted in between is known. When the belt shaft is locked and the passenger is exposed to a forward displacement, the torsion bar is plastically twisted around its own axis and thus acts as a load limiting device.

However, a disadvantage in this embodiment is that the part of the belt shaft, upon which the safety belt is wound, is radially deflected during the load limited extraction movement owing to the tensile force exerted by the safety belt so that, in addition to the torsional load, an alternating bending load is generated in the load limiting device. Thereby, the belt extraction movement is needlessly disturbed during the load limited forward displacement and, besides the torsional moment, a bending moment is further introduced into the load limiting device, which bending moment leads to an unbalanced and very complex stress condition in the load limiting device during its superposition to the torsional moment.

### SUMMARY OF THE INVENTION

It is an object of the invention to provide a seat belt retractor with a two-part belt shaft and a load limiting device located between the parts of the belt shaft, in which seat belt retractor the forces and moments introduced into the load limiting device are introduced distributed as evenly as possible throughout the extent and the temporal course of the load limiting.

For the solution of the object, a seat belt retractor with a two-part belt shaft including a first part of the belt shaft, upon which the safety belt is wound, and a second part of the belt shaft, which can be locked in a vehicle-fixed manner in relation to a housing of the seat belt retractor, and a load limiting device located between the first and the second part of the belt shaft is proposed, wherein the first and the second part of the belt shaft axially overlap at least in sections, and a bearing ring is provided in the overlapping area.

By the proposed bearing ring, the two parts of the belt shaft rotating relatively to each other during the load limited forward displacement of the passenger are mounted towards each other so that the first part of the belt shaft is no longer radially deflected in relation to the second part, which is locked in a vehicle-fixed manner, and, thereby, the relative movement acting upon the load limiting device is formed from a pure rotational movement. Thus, moments and forces, which are distributed considerably more evenly, are introduced into the load limiting device, as the relative rotational movement is effected in a controlled and mounted manner by means of the bearing ring. Ideally, only torsional moments are thus introduced into the load limiting device.

It is further proposed that the bearing ring is connected in a rotationally fixed manner, and preferably in a positively locking manner, to the first or the second part of the belt shaft. Thereby, the bearing ring is clearly assigned to one of the two parts of the belt shaft and acts as a bearing for the respective other part. In this case, the rotationally fixed connection can be realized in a particularly easy way by means of a positively locking connection, in particular when the bearing ring is made of a plastic as an injection molded part.

It is further proposed that the bearing ring is made of a material having a lower hardness than the first and the second part of the belt shaft. It is thereby ensured that the parts of the belt shaft can perform the required relative rotational movement towards each other without the risk of the parts being damaged thereby, as flexibility has been provided by means of the deliberately softer bearing ring. Furthermore, the bearing ring can thereby be slid onto one of the parts of the belt shaft in a self-cutting manner, wherein it is ensured that the part of the belt shaft cuts into the bearing ring and not vice versa.

A further preferred embodiment of the invention is that the height of the bearing ring is greater than its width. By designing the cross-section of the bearing ring according to the invention, on the one hand, a wall thickness sufficient for establishing the positively locking connection is provided, and, on the other hand, the two parts of the belt shaft are definitely prevented from touching at each other in case of abrasion of the bearing ring.

It is further proposed that a tensioner drive wheel is located on the second part of the belt shaft, and that the tensioner drive wheel laterally rests against the bearing ring. Thereby, a tensioner drive wheel to be provided can laterally be secured by the bearing ring at least during a pre-assembly phase.

Moreover, the seat belt retractor can comprise a housing with a U-shaped base frame, and openings can be provided in the opposite brackets of the base frame, into which openings the two-part belt shaft extends, and the bearing ring can be located in a section of the two-part belt shaft, which section is located in the area where the belt shaft passes through one of the openings with the seat belt retractor being assembled. Thereby, the radial forces generated in the bearing ring during the load limited relative movement of the two parts of the belt shaft are introduced into the housing of the seat belt retractor in a reliable and in the most direct manner possible.

Such an embodiment particularly lends itself at the time when the belt shaft is mounted in the openings by means of emergency run bearings operative during the load limited extraction movement, as a slight radial deflection of the belt shaft is then limited by the emergency run bearings.

It is further proposed that the first part of the belt shaft and the second part of the belt shaft are connected to each other in the circumferential direction by the bearing ring via a clamping connection, and that the clamping connection between the first and the second part of the belt shaft can be disconnected, in case, a belt extraction force which is below the load limiting level defined by the load limiting device is exceeded. Thus, the bearing ring, besides its bearing function, further has the function to connect the two parts of the belt shaft to each other in the circumferential direction so that the belt shaft acts as a one-piece belt shaft during normal operation, and the locking of the second part of the belt shaft causes an immediate locking of the first part of the belt shaft as well.

A further preferred embodiment of the invention is that the load limiting device is formed by a torsion bar, and that the bearing ring is located in a plane cutting the torsion bar between its ends. By means of the proposed arrangement of the bearing ring, the guidance of the rotating first part of the belt shaft in relation to the second part, which is fixed during the load limiting phase, is further improved. In addition, the length of the torsion bar can be chosen independent of the width of the first part of the belt shaft, upon which first part the safety belt is wound.

It is further proposed that the first part of the belt shaft and the second part of the belt shaft are connected to each other in the axial direction via the bearing ring. The connection can be established for example by means of a press fit or even by means of a form-closure connection. The connection of the first and the second part of the belt shaft in the axial direction guarantees that both parts stay securely connected to each other as an assembly over the life time of the seat belt retractor, and that they are not pushed apart during the load limiting phase by a lengthening of the load limiting device, in particular of a torsion bar.

### BRIEF DESCRIPTION OF THE DRAWINGS

In the following, the invention is described in more detail on the basis of a preferred embodiment. In the drawings,

FIG. 1 shows a cross-sectional view of seat belt retractor with two-part belt shaft and bearing ring;

FIG. 2 shows an enlarged representation of two-part belt shaft with bearing ring;

FIG. 3 shows a view according to the cutting direction A-A from FIG. 2; and

FIG. 4 shows a bearing ring.

### DETAILED DESCRIPTION OF THE DRAWINGS

FIG. 1 shows a seat belt retractor with a two-part belt shaft comprising a first part 1, upon which a safety belt 2 is wound, and which can be locked in a vehicle-fixed manner via a second part 5. The two-part belt shaft is located in a housing 8 formed by a U-shaped base frame and engages through openings 20 and 21 provided in the opposite brackets 8a and 8b of the housing 8. A torsion bar acting as load limiting device 3 is located between the first part 1 and the second part 5. The torsion bar 3 is connected to the first part 1 of the belt shaft with its first end 3a and to the second part 5 of the belt shaft with its second end 3b. A locking pawl 4, which can be controlled in a vehicle-sensitive and/or a belt webbing-sensitive manner, is mounted on the second part 5, which locking pawl in the event of actuation engages the belt shaft into a toothing 19 of a tensioner housing 9 firmly connected to the housing 8 in a vehicle-fixed locking manner.

Furthermore, a further housing 12 can be seen on the locking side of the seat belt retractor, in which housing the belt shaft is mounted with a pin 11. Moreover, a control unit 10 is located in the housing 12, by which control unit the locking pawl 4 can be controlled in a belt webbing-sensitive and/or a vehicle-sensitive manner. A bearing ring 13 is provided in the area of axial overlapping between the first part 1 of the belt shaft and the second part 5 of the belt shaft. The first part 1 of the belt shaft is mounted on the second part 5 of the belt shaft via the bearing ring 13 so that the first part 1 of the belt shaft performs a relative rotational movement as controlled as possible without a radial deflection in relation to the second part 5 during the load limiting phase with the second part 5 being locked. By means of the relative rotational movement guided like this, the torsion bar provided between both parts 1 and 5 of the belt shaft is ideally only exposed to a torsional load during the load limiting phase.

In the assembled state of the belt shaft, the bearing ring 13 is located in the area where the same passes through the opening 21. As the belt shaft is further loaded with a radial force by the safety belt during the load limiting phase, the belt shaft touches at the emergency run bearings in the region of the openings 20 and 21 in the event of a slight radial deflection. Owing to the arrangement of the bearing ring 13, the radial forces from the first and the second part of the belt shaft thus are directly introduced into the housing 8 so that the whole assembly of the belt shaft is not deformed at all or only to a minimum. In doing so, it is further ensured that the end 3a rotating together with the first part 1 performs a pure rotational movement in relation to the end 3b, and that no or only minimal bending moments are introduced into the torsion bar.

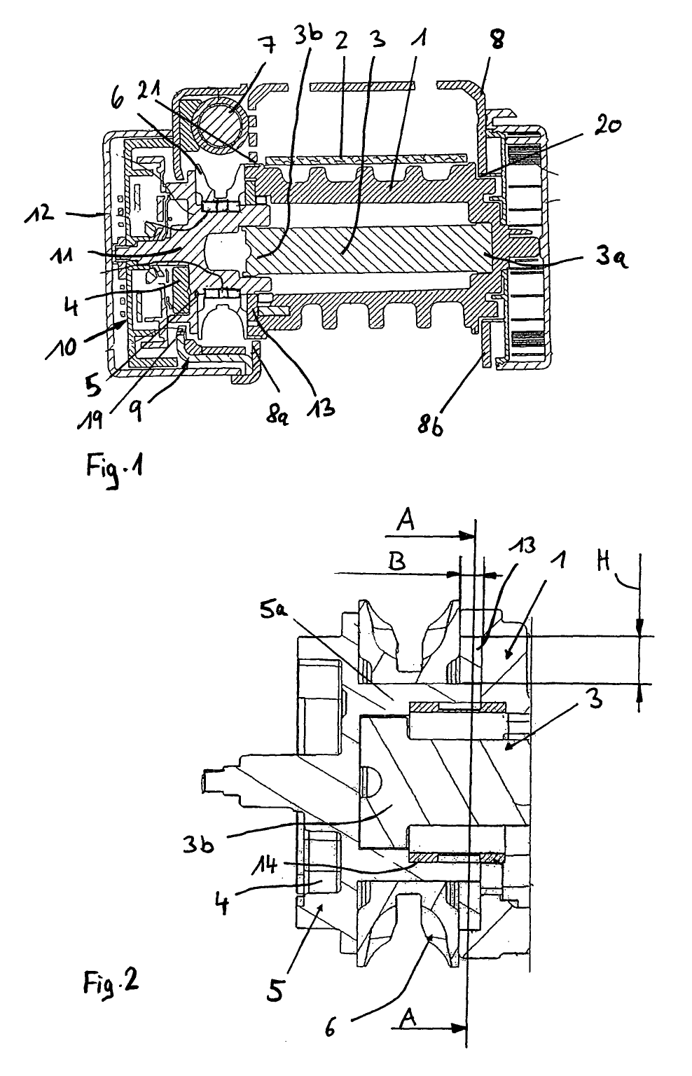

FIG. 2 shows an enlarged cut-out of the locking side of the two-part belt shaft. A tensioner drive wheel 6 is located on the second part 5, which tensioner drive wheel can be driven by a bead chain 7 shown in FIG. 1. The tensioner drive wheel 6 is slid onto a ring cylindrical appendix 5a of the second part 5 of the belt shaft and laterally rests against the bearing ring 13. A connecting element 14 is further provided between the first part 1 and the second part 5 of the belt shaft, by which connecting element both parts of the belt shaft are connected to each other bridging over the torsion bar. Owing to the connection via the connecting element 14, the belt shaft can be regarded as a one-piece belt shaft during the normal operation or during the tensioning movement. As an alternative or in addition, the bearing ring 13 can also be located between the first part 1 and the second part 5 of the belt shaft via an interference clamping connection so that the two parts of the belt shaft are held together axially and in the circumferential direction by the bearing ring 13, and the torque and the axial forces can be transmitted between the parts 1 and 5 of the belt shaft via the bearing ring 13.

A further function of the bearing ring 13 is that the tensioner drive wheel 6 is secured by the same on the ring cylindrical appendix 5a in a pre-assembly.

Furthermore, the end 3b of the torsion bar is fixed in the ring cylindrical appendix 5a so that the ring cylindrical appendix 5a is used in a functional unity for mounting the first part 1 of the belt shaft in relation to the second part 5 of the belt shaft as well as for transmitting the forces during the tensioning process and during the load limiting resulting in an overall very compact configuration of the seat belt retractor with few single components.

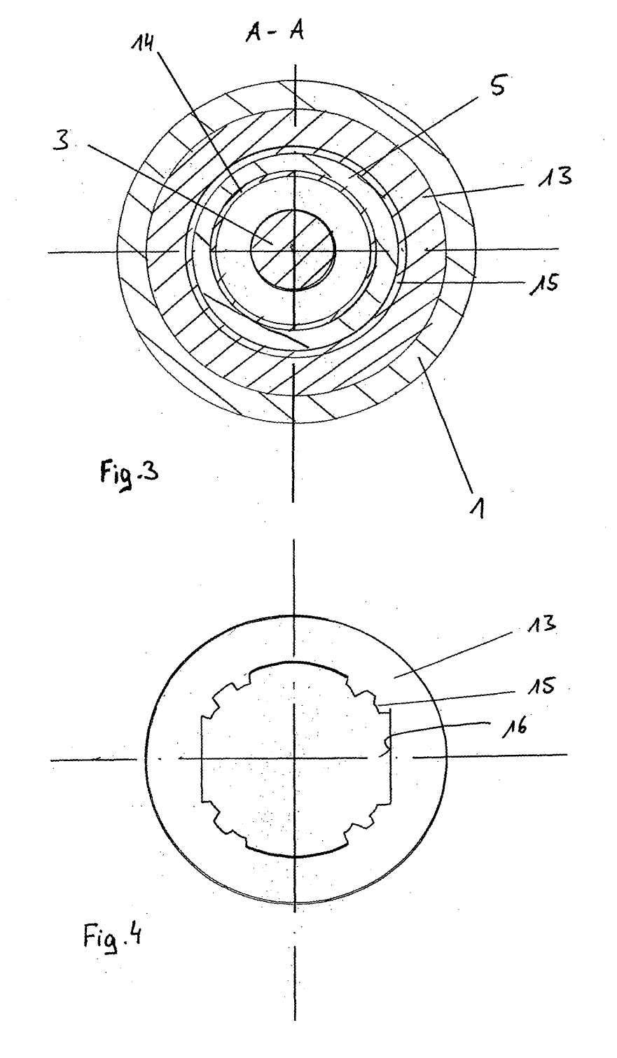

For a better understanding of the invention, FIGS. 3 and 4 show the bearing ring 13 and its arrangement according to the cutting direction A-A from FIG. 2. The plane defined by the bearing ring 13 corresponds to the cutting direction A-A and visibly runs between the ends 3a and 3b of the torsion bar. This provides the possibility to use a torsion bar, which is substantially longer than the width of the first part of the belt shaft and to thereby further modify the load limiting level. Furthermore, the whole assembly is centrally supported between the ends of the load limiting device 3 by the bearing ring 13 during the load limited belt extraction movement so that the maximum lever arms operative are reduced to the bearing and the relative rotational movement is particularly well supported.

The bearing ring 13 is fastened on the second part 5 in a positively locking and rotationally fixed manner via a toothing 15 and two lateral flat spots 16. As the bearing ring 13 is preferably made of a material having a lower hardness in comparison to the second part 5, the bearing ring 13 can adjust itself in its form while being slid onto the second part 5 of the belt shaft and can secure itself in a rotationally fixed manner by the second part 5 cutting in.

What is claimed is:

1. A seat belt retractor with a two-part belt shaft comprising a first part of the belt shaft, upon which a safety belt is wound, and a second part of the belt shaft, configured to be locked in a vehicle-fixed manner in relation to a housing of the seat belt retractor, and a load limiting device acting between the first and the second part of the belt shaft, the first and the second part of the belt shaft axially overlapping in an overlapping area, and a bearing ring being arranged in the overlapping area.

2. The seat belt retractor according to claim 1, further comprising that the bearing ring is connected in a rotationally fixed manner to one of the first and second parts of the belt shaft.

3. The seat belt retractor according to claim 2, further comprising that the bearing ring is connected in positively locking manner to the one of the first and second parts of the belt shaft.

4. The seat belt retractor according to claim 2, further comprising that the bearing ring is made of a material having a lower hardness than the one of the first and second parts of the belt shaft to which the bearing ring is connected.

5. The seat belt retractor according to claim 1, further comprising that the bearing ring has greater height (H) than width (B).

6. The seat belt retractor according to claim 1, further comprising that a tensioner drive wheel is located on the second part of the belt shaft, and that the tensioner drive wheel laterally rests against the bearing ring.

7. The seat belt retractor according to claim 1, further comprising that the housing of the seat belt retractor is formed from a U-shaped base frame comprising two opposite brackets with openings, into which the two-part belt shaft extends, and that the bearing ring is located in a belt shaft section in which the belt shaft passes through one of the openings.

8. The seat belt retractor according to claim 7, further comprising that the two-part belt shaft is mounted in the openings in emergency run bearings that are operative during a load limited extraction.

9. The seat belt retractor according to claim 1, further comprising the load limiting device defines a load limiting level, that the first part of the belt shaft and the second part of the belt shaft are connected to each other by the bearing ring via a clamping connection, and that the clamping connection between the first and the second part of the belt shaft is releasable when a predefined belt extraction force is exceeded, the predefined belt extraction force being greater than zero and smaller than the load limiting level.

10. The seat belt retractor according to claim 1, further comprising that the load limiting device is formed by a torsion bar with two ends, and that the bearing ring is located in a plane intersecting the torsion bar between the two ends.

11. The seat belt retractor according to claim 1, further comprising that the first part of the belt shaft and the second part of the belt shaft are coaxially connected to each other via the bearing ring.
